(19) United States
(12) Patent Application Publication
(10) Pub. No.: US 2013/0220902 A1
(43) Pub. Date: Aug. 29, 2013

(54) PLC SYSTEM FOR AUTOMATICALLY CONTROLLING PID FOR MAINTAINING TARGET WATER QUALITY VALUE BY DEPOSITING WATER TREATMENT CHEMICAL

(71) Applicants: Tae Il Lee, Seoul (KR); Ho Jin Kim, Seoul (KR)

(72) Inventors: Tae Il Lee, Seoul (KR); Ho Jin Kim, Seoul (KR)

(73) Assignee: TAE IL LEE, Seoul (KR)

(21) Appl. No.: 13/882,562

(22) PCT Filed: Jan. 25, 2011
(86) PCT No.: PCT/KR2011/000501

§ 371 Date: Apr. 30, 2013

(30) Foreign Application Priority Data
Nov. 1, 2010 (KR) 10-2010-0107647
Jan. 25, 2011 (KR) PCT/KR2011/000501

(51) Int. Cl. C02F 1/00

(52) U.S. Cl. CPC C02F 1/008
USPC 210/96.1

(57) ABSTRACT

A PLC system for automatically controlling PID for controlling the target value for residual chemicals in a water treatment facility, according to the present invention, comprises: a PID control software; a main control room computer for generating a PID control command regarding chemical deposit amount and relaying same to a field control PLC in a chemical room; the field control PLC in the chemical room for receiving a PID control command signal from the main control room computer and performing computing and control; and a chemical depositor in the chemical room for receiving the control signal from the field control PCL and depositing the indicated amount of chemicals, wherein the main control room computer calculates an initial setting value for the chemical deposit amount and generates the PID control command.

### CROSS-REFERENCE TO RELATED APPLICATION

This application claims the benefit of Korean Patent Application No.10-2010-0107647, filed on Nov. 1, 2010 in the Korean Intellectual Property Office, the disclosure of which is incorporated herein by reference.

### TECHNICAL FIELD

The present invention relates to a PID automatic control system which makes it possible to change the input amount of a chemical for the purpose of properly maintaining a target water quality whenever a flow amount or water quality changes during a disinfection process of a water treatment facility, and in particular to a PLC system for a PID automatic control which helps perform a PID automatic control in accurate and stable ways without using a PID controller.

### BACKGROUND ART

Tap water is generally supplied to a user through a pipe after raw water for water supply is collected and purified in a water purification plant; however in the water purification plant, the raw water for water supply is purified through multiple processes. Chlorine(Cl₂) is mainly used as a disinfectant during a water purification for the reasons that it is cheaper than other disinfectants and is chemically safe, while having many residues. In other words, since chlorine remains underwater as a residual chlorine after disinfection is finished, the residual chlorine serves to prevent the recontamination by bacteria during the drainage of water, so the water can be managed in safe ways. So, the chlorine is injected for free residual chlorine to remain as much as 0.1mg/L before the water is supplied, which helps obtain a bacteriological safety in all water supply pipe systems. The amount of the above mentioned residual chlorine helps adjust the amount of the chlorine which is added during an actual disinfection work for thereby preventing the loss of chlorine and achieving an effective disinfection.

Meanwhile, the water treatment system uses a PID automatic control method for the purpose of changing the input amount of chemical so as to maintain a proper level of target water quality items whenever the flow amount or water quality changed during a chemical input process. Here, the PID automatic control (Proportional-Integral-Differential Auto-Control) means a feedback automatic control, in which the output value of the object is measured and compared with a set point for thereby calculating errors, and the values used in an automatic control are calculated as a proportion-integration-differentiation item using the error values. In the conventional art, the DCS (Distributed Control System) or the PLC (Programmable Logic Controller) system were used for the PID automatic control system.

FIG. 1 is a block diagram illustrating a DCS system for a conventional PID automatic control.

As shown in FIG. 1, in the main control room are provided a computer 100 and a master station 102 for thereby generating a PID control command. Here, the master station 102 is selective, and depending on the implementation, the computer 100 may be configured to serve as the main control room for thereby generating a PID control command.

In a chemical room are provided a remote station 104, a PID controller 106 and a chemical feeder 108. The remote station 104 helps computer the indication feed amount in the PID automatic control. The PID controller 106 receives a calculation value of the remote station 104 and controls the amount of the chemical which will be fed, and the chemical feeder 108 receives a signal from the PID controller 106 and feeds the chemical as much as commanded.

The PCS system for a PID automatic control has a high accuracy; however the price is very expensive, so the PLC system is widely used instead.

FIG. 2 is a block diagram for explaining the PKC system for a conventional PID automatic control.

As shown in FIG. 2, in the main control room are provided a computer 200 and a master PLC 202 for generating a PID control command. Here, the master PLC 202 is selective, and depending on the implementation, the computer 200 may be configured to serve as the main control room for thereby generating a PID control command.

In the chemical room are provided a field control PLC 204, a PID controller 206, and a chemical feeder 208. The field control PLC 204 serves to collect the operation/idles of various field devices and the open and close and the state values of the meters and transmit to the main control room and transfer the command signals from the main control room to the field devices. Different from the DCS system, the PID controller 206 of the PLC system receives a signal from the field control PLC 204 and performs the calculation and control of the amount of the chemical, and the chemical feeder 208 receives a signal from the PID controller 206 and feeds the chemicals as much as commanded.

In the water treatment facility, even when the treatment flow amount or water quality changes, the target water quality should be maintained in safe by using the PID automatic control method; however the PD automatic control system using a PID controller is expensive, so the automatic control method should be improved so that the same effects as the conventional PID automatic control system can be obtained while saving moneys.

### DISCLOSURE OF INVENTION

Accordingly, the present invention is made based on the above mentioned conventional art and it is an object of the present invention to provide a PLC system for a PID automatic control which makes it possible to perform a PID automatic control in safe and accurate ways without using a PID controller.

To achieve the above objects, there is provided a PLC system for automatically controlling a PID for maintaining a target water quality value by depositing water treatment chemical, comprising a computer provided in a main control room which computer is equipped with a PID control software and generates a PID control command with respect to a chemical feed amount and transfer to a field control PLC of a chemical room; a field control PLC provided in the chemical room which field control PLC receives a PID control command signal from the computer of the main control room and performs a calculation and control; and a chemical feeder provided in the chemical room which chemical feeder receives a control signal of the field control PLC and feeds a chemical as much as commanded, and the computer of the main control room calculates an initial set value of the chemical feed amount based on Equation 1 and generates a PID control command.

[Equation] Initial set value=[current actual feed amount+(residual chemical target value−residual chemical actual measured value)]×flow amount.

In the equation, the current actual feed amount represents the actual feed ratio of the chemical in comparison to the treatment flow amount, and the residual chemical target value represents a concentration value of the residual chemical targeted after the chemical feed process, and the residual chemical actual measured value represents an actual measured value of the current residual chemical, and the flow amount represents the amount of water which is treated in the chemical feed field.

Here, the computer of the main control room sets a control range of a PID automatic control which control range is formed of a proportional factor, an integration factor, a calculation period and a compensation deviation which are defined by the capacities of the chemical feeder depending on the water quality for thereby generating a PID control command.

Furthermore, the computer of the main control room compares at every second the current flow amount with the flow amount of one minute ago, and when the difference between the current flow amount and the flow amount of one minute ago is less than ±10%, the set value of the current chemical feed amount is maintained identically, and when the difference between the current flow amount and the flow amount of one minute ago is above ±10%, the flow amount compensation chemical feed set value is recalculated on the basis of Equation 2, for thereby generating a PID control command.

[Equation] Flow amount compensation chemical feed amount set value=chemical feed amount before change of flow amount+[(current flow amount−flow amount of one minute ago)×chemical feed ratio before change of flow amount]

At this time, when the flow amount compensation is performed by the flow amount compensation chemical feed amount set value, the flow amount compensation is not performed for one minute.

### Advantageous effects

The present invention makes it possible to minimize the maximum error range occurrence and the stabilization lead time by establishing an initial set value automatic input function in a computer of a main control room, and the accuracy can be improved by setting a control rang by the capacity of the feeder by detecting when the water quality is good or bad. In addition, since the chemical feed amount set value is changed depending on the change of flow amount, the change in the flow amount can be compensated.

Therefore, according to the PLC system for an improved PID automatic control of the present invention, even when the water intake amount changes or the water quality of

Han river becomes bad, it is possible to keep maintaining the stable concentration of residual disinfections, and significant budget saving effects can be obtained.

### BRIEF DESCRIPTION OF DRAWINGS

FIG. 1 is a block diagram for explaining a DCS system for a conventional PID automatic control.

FIG. 2 is a block diagram for explaining a PLC system for a conventional PID automatic control.

FIG. 3 is a block diagram for explaining a PLC system for a PID automatic control according to the present invention.

FIG. 4 is a graph showing an initial set value calculation window in an actual operation screen of a computer of a main control room.

FIG. 5 is a graph showing a state that a reach time to a stabilization state significantly decreases due to the input of an initial set value.

FIG. 6 is a graph showing a PID automatic control calculation optimum factor of a small capacity chlorine feeder which is used when water quality is good.

FIG. 7 is a graph showing a PID automatic control calculation optimum factor of a large capacity chlorine feeder which is used when water quality is good.

FIG. 8 is a view of an analysis screen of a prechlorination practice trend when water quality is usual.

FIG. 9 is a view of an analysis screen of a prechlorination practice trend when water quality fast changes.

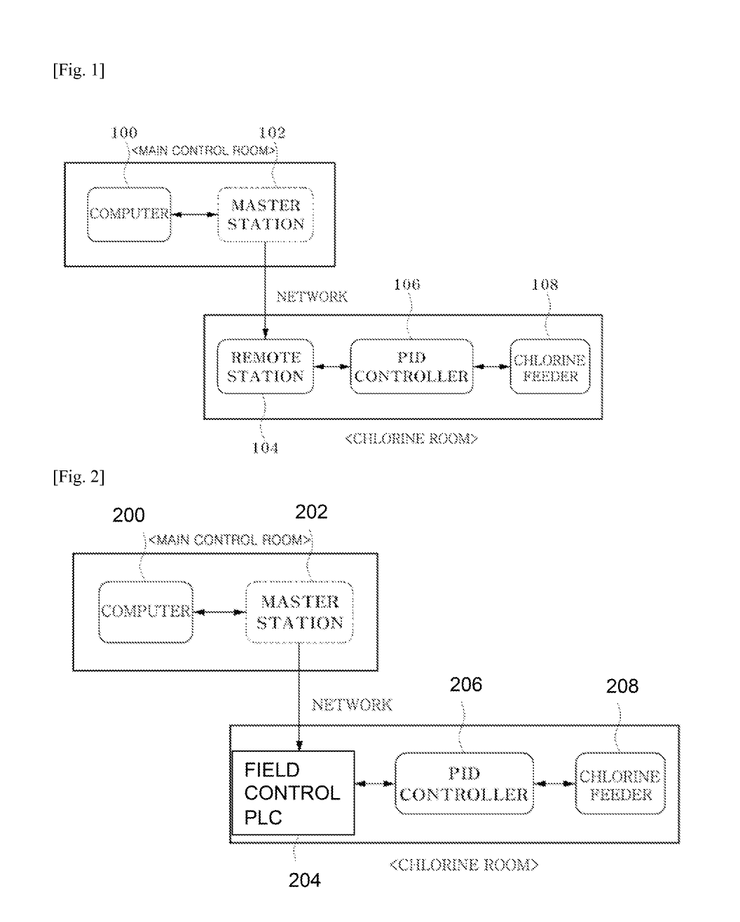

### BEST MODE FOR CARRYING OUT THE INVENTION

The preferred embodiments of the present invention will be described with reference to the accompanying drawings. The following embodiments are disclosed to an extent that those who skilled in the art can fully understand the present invention, and various modifications are possible, and it is understood that the scope of the present invention is not limited by the following disclosures.

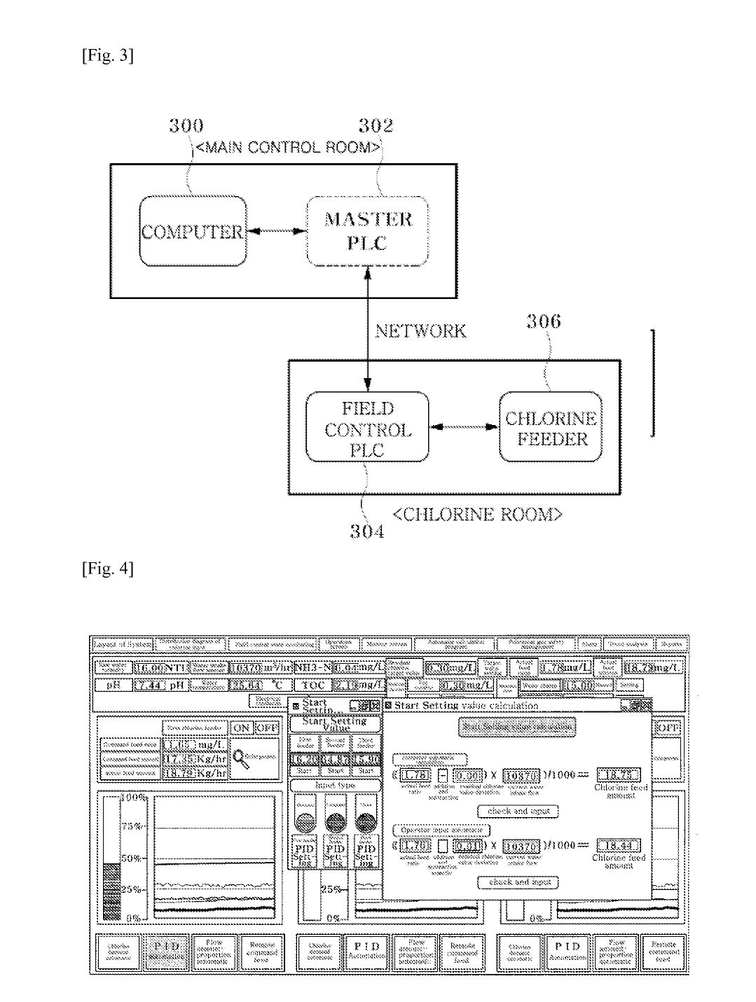

FIG. 3 is a block diagram for explaining a PLC system for a PID automatic control according to the present invention.

As shown in FIG. 3, the master PLC 302 of the main control room, the field control PLC 304 of the chemical room and the chemical feeder 306 are similar with those of the conventional PLC system of FIG. 2; however the PLC system for a PID automatic control according to the present invention has features in that the PID controller arranged in the chemical room of FIG. 2 is removed, and the computer 300 of the main control room is equipped with a PID control software instead. In other words, the computer 300 of the main control room generates a PID control command using the installed PID control software, and the master PLC 302 receives a PID control command signal and transfer to the field control LC 304 of the chemical room. Here, the master PLC 302 is selective, and depending on its implementation, the computer 300 may be configured to serve as the main control room for thereby generating a PID control command.

The field control PLC 304 of the chemical room is configured to perform a calculation and control in response to a received PID control command signal. The chemical feeder 306 receives a control signal of the field control PLC 304 and feeds chemicals as much as commanded.

The PID control by the computer 300 of the main control room equipped with the PID control software has the following features.

First, so as to prevent the maximum error occurrence in the operation initial PID control and minimize the stabilization lead time, there is an initial setting value automatic input function of the chemical feed amount.

The initial set value (kg/hr) of the chemical feed amount can be calculated as follows.

*initial set value=[current actual input ratio+(residual chemical target value−residual chemical actually measured value)]×flow amount

In the formula, the current actual feed ratio represents the actual feed ratio(mg/L) of the chemical when comparing to the treatment flow amount. The residual chemical target value represents the concentration value (mg/L) of the residual chemical targeted after the disinfection chemical feed process. The residual chemical actually measured value represents the actually measure value (mg/L) observed after the current disinfection process. The flow amount represents the flow amount (tons/hr) when the target residual chemical is controlled and processed at the chemical feed field.

The computer of the main control room fast and accurately calculates the initial set value of the chemical feed amount in consideration of the process flow amount, the current chemical actual feed ratio and the deviated value between the target value and the actually measured value of the chemical residual concentration and transfers the calculated value to the chemical room for commands. Therefore, the present invention can provide effects of minimizing the maximum error range occurrence and the stabilization lead time that generally occur in the PID equipment.

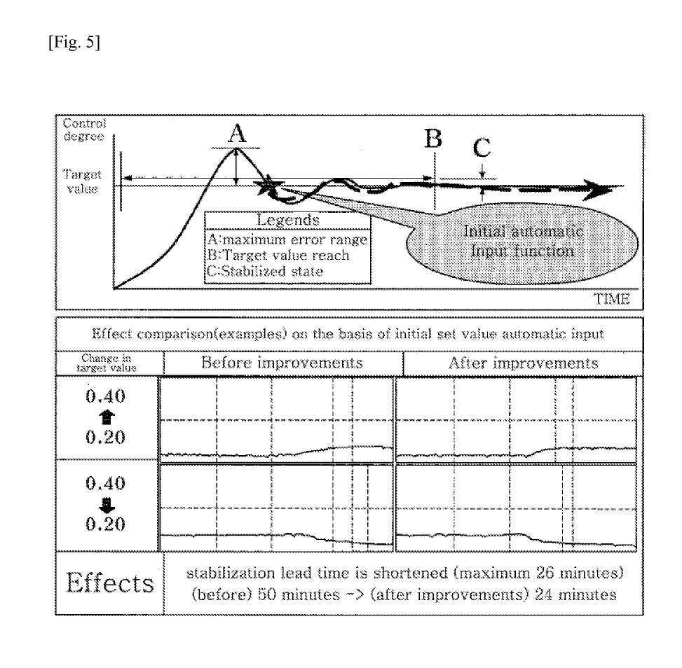

FIG. 4 is a graph showing an initial set value calculation window in an actual operation screen of a computer of a main control room. FIG. 5 is a graph showing a state that a reach time to a stabilization state significantly decreases due to the input of an initial set value. As shown in FIG. 5, if it is assumed that the stabilization lead time of the PLC system for a PID automatic control without the conventional initial set value automatic input function is 50 minutes, the stabilization lead time of the PLC system for a PID automatic control according to the present invention which is equipped with an initial set value input function is 24 minutes, which was approved through the experiments.

Second, the PLS system for a PID automatic control according to the present invention is capable of enhancing the accuracy by setting the range of control by the capacity of the chemical feeder by detecting when the water quality or good or bad. In other words, the chemical feeders are provided in multiple numbers, and the capacities of the feeders are diversified, so the PID controls are different by the capacities of the feeders.

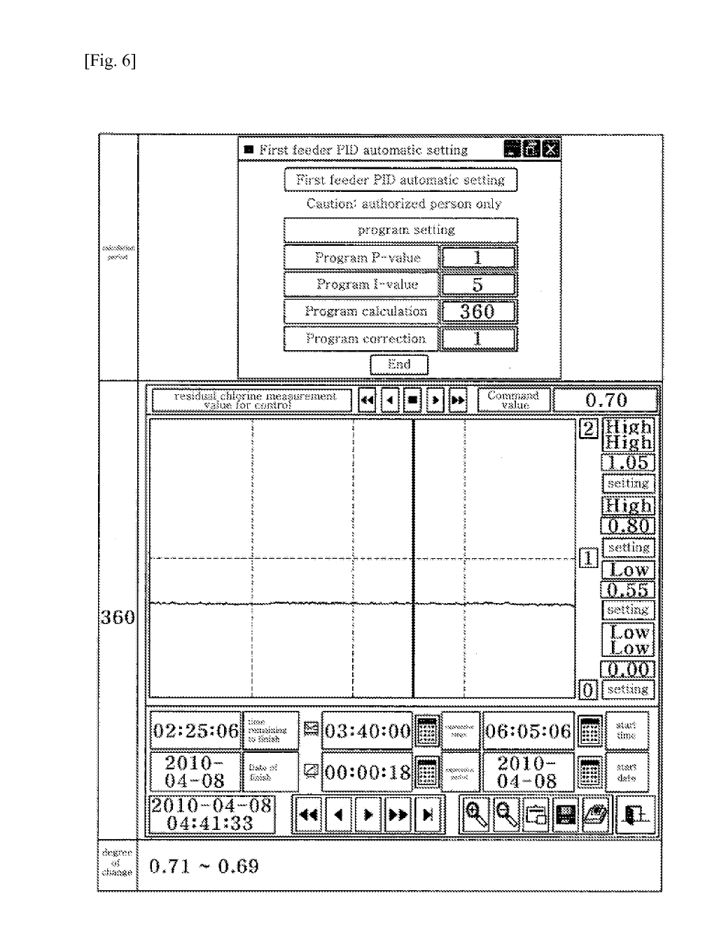

For example, when the water quality of the water intake plant is good, and the capacity of the first chemical feeder is 37.8 kg/h, the calculation optimum factor of the PID automatic control, as shown in FIG. 6, has 1 of a proportional factor, 5 of an integration factor, 360 SEC of a calculation period and 1 of a correction deviation (for example, when the chemical is chlorine).

The range of the correction deviation is 1 to 4,000, for example, if the deviation between the target value and the measured value of the residual chemical concentration is above 1/4,000, it presents commanding the calculation control to continue until the value becomes less than 1/4,000. Here, the vale “P” represents a factor with which the operation degree becomes the size proportional to the difference between the target value and the current position. If the control degree actually becomes closer to the target value, problems occur because the operation degree becomes too small, and it is impossible to control up to that degree in too accurate degrees. In other words, the degrees become closer to the target value, but it does not perfectly reach the control degree even when too much time passes, the small error of which represents “residual deviation”. The integration control is used so as to eliminate such residual errors. In other words, it operates in such a way that the small residual deviations are accumulated over time, and the deviations are eliminated by increasing the operation degree at a certain increasing value point. The value “I” is a factor with which when the integration time becomes longer, the operation degree lowers, and the time taking to approach the reference value becomes longer, and when the integration time is shorter, the operation degree rises, and the time taking to approach the reference value becomes shorter.

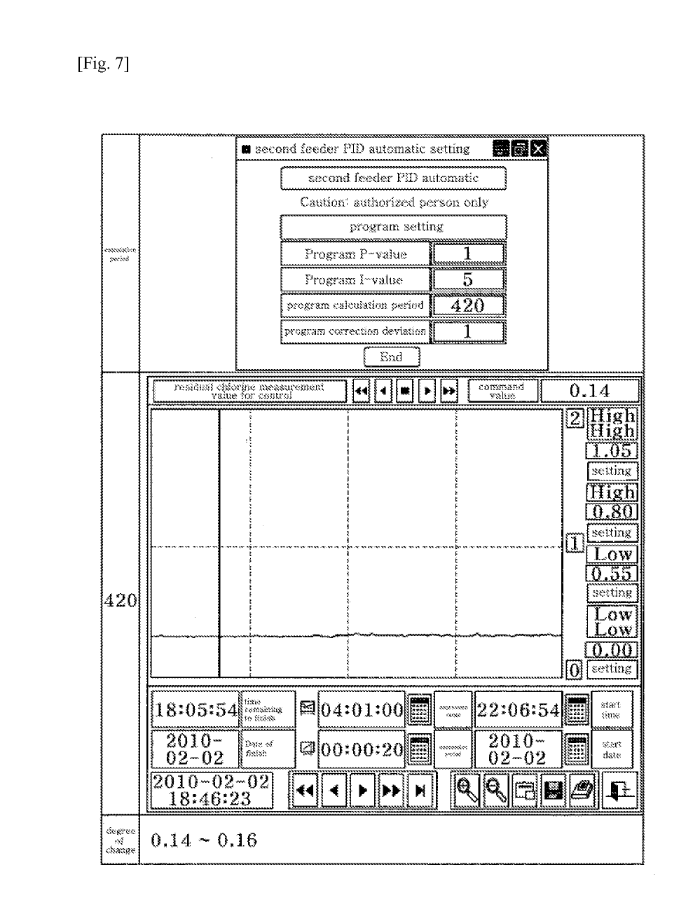

However, if the capacity of the second chemical feeder is 113.4 kg/h, which is used when the water quality becomes worse, and it needs to increase the amount of feed, as shown in FIG. 7, the PID automatic control calculation optimum factor has 1 of a proportional factor 1, 5 of an integration factor, 420 SEC of a calculation period and 1 of a correction deviation, which values are changed.

The graphs of FIGS. 6 and 7 are example graphs showing that a small capacity chemical feeder used when the water quality is good and a large capacity chemical feeder used when the water quality is bad should have changed PID control range so that the trends of the graphs can be stable, and the maintenance and management of the water quality is continuously maintained. The graphs also show that the results of the operations are accurately maintained within a range (mg/L) of 2/100 million in terms of the target value to measured value.

Referring to FIGS. 6 and 7, it is confirmed that the PID control set value of the small capacity chemical feeder used when the water quality is good should not be identically adapted to when the PID control of the large capacity chemical feeder, which is used when the water quality become worse, is set.

Therefore, the PLC system for a PID automatic control according to the present invention has features in that the chemical feeders are provided in multiple numbers, and the control ranges are set by the capacities of the chemical feeders by detecting when the water quality is good or bad, so the accuracy of the PID control can be enhanced.

Third, the PLC system for a PID automatic control according to the present invention has a function of compensating the change of the flow amount when there are changes in the increase and decrease of the time-based treatment flow amount on the basis of the amount of demands, so the accuracy can be enhanced more. In other words, the PID control by the computer 300 of the main control room with a PID control software is equipped with a flow amount compensation function even when there is a change in the increase and decrease of the treatment flow amount, so the target water quality values when feeding chemicals cab be maintained in proper states in stable and continuous ways.

In more details, the chemical feed setting values for the sake of compensation of the flow amount when the flow amount (tons/hr) increases or decreases can be calculated as follows.

At every second, the current flow amount is compared in real time with the flow amount of one minute ago, and if a result of the comparison when comparing the flow amount of one minute ago with the current flow amount is less than ±10% of the flow amount of one minute ago, the current chemical feed set value is maintained, and if a result of the comparison when comparing the flow amount of one minute ago with the current flow amount is above ±10% of the flow amount of one minute ago, the flow amount compensation chemical feed set value is recalculated, provided that the flow amount compensation is not performed for one minute after the flow amount compensation is once performed.

The flow amount compensation chemical feed set value can be calculated as follows.

*flow amount compensation chemical feed set value (kg/hr)=chemical feed amount (kg/hr) before change of flow amount+{(current flow amount(tons/hr)=flow amount of one minute ago(tons/hr)×chemical feed ratio(mg/L) before change in flow amount)}

For example, if the flow amount of water intake of one minute ago is 8,800 tons/hr, and the current is 10,800 tons/hr, the change of the flow amount is +2,000 tons, which means above 10% of the water intake flow amount of one minute ago, so the flow amount compensation process starts activated, and the flow amount compensation chemical feed set value is calculated. If the chemical feed amount before the change of the flow amount is 20 kg/hr, and the chemical feed ratio is 2.04 mg/L, the flow amount compensation chemical feed set value(kg/h) can be calculated as follows.

*flow amount compensation chemical feed set value(kg/h)=20 kg/h+{(10,800 tons/hr−8,800 tons/hr)×2.04 mg/L}=24.08 kg/h

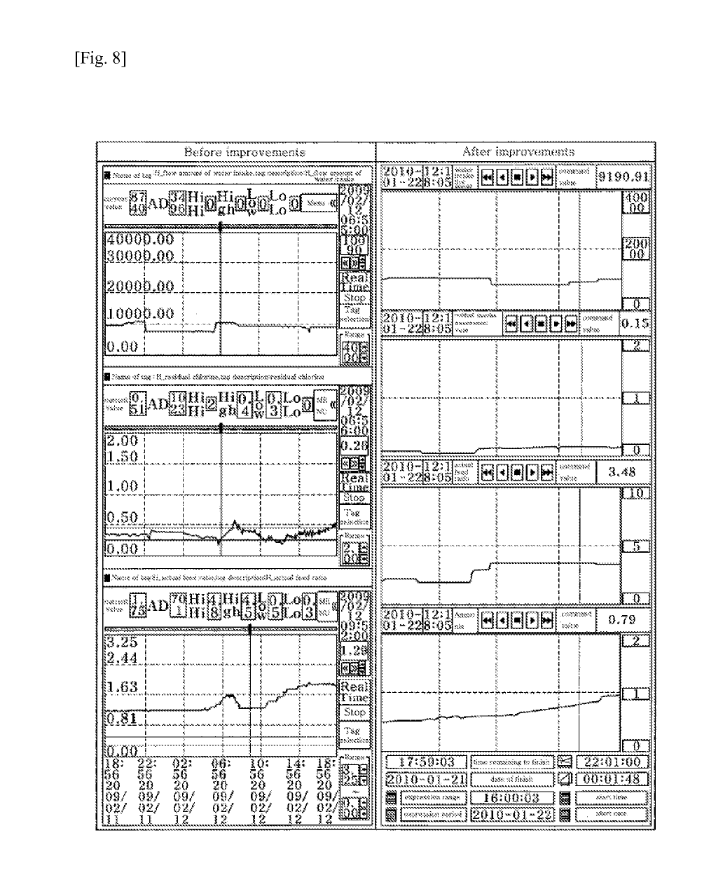

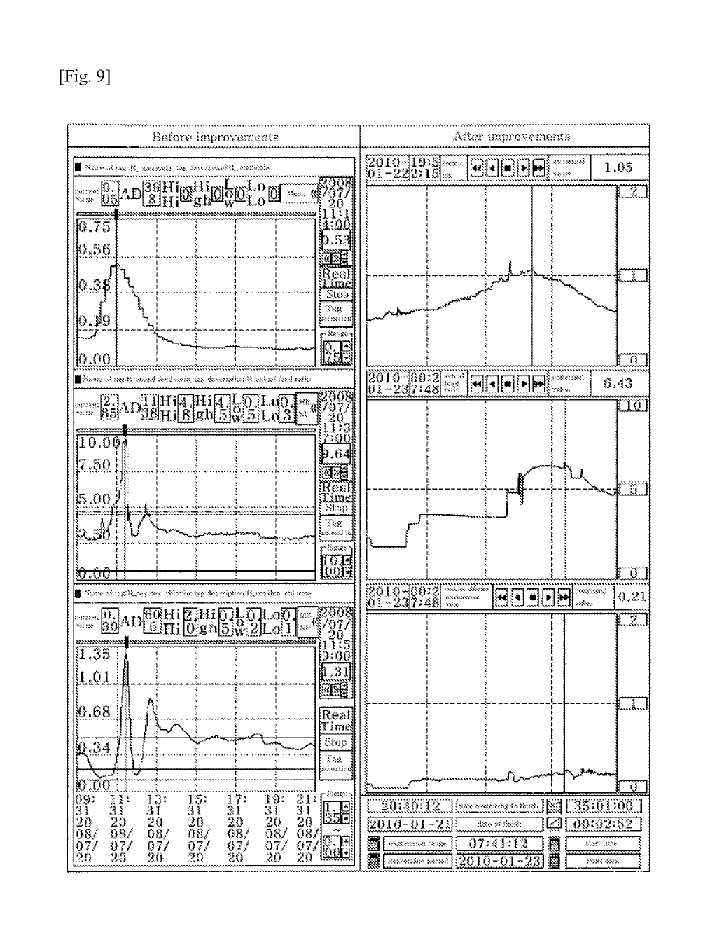

FIGS. 8 and 9 showing that the pre-treatment disinfection process efficiencies with respect to the changes in water quality of the present invention are greatly improved will be described.

FIG. 8 is a view of an analysis screen of a prechlorination practice trend when water quality is usual.

As shown in FIG. 8, referring to the graphs of the left side before the improvements, it is known that when the water intake flow amount decreases, the residual chlorine increases, and when the water intake flow amount increases, the residual chlorine decreases. In other words, it is known that even by a slight change in water quality, the prechlorination practice ratio(1.29-2.11 mg/L) and the residual chlorine(0.13-0.63 mg/L) become unstable.

On the contrary, referring to the graphs after improvements of the right side of FIG. 8 to which the present invention is adapted, it is known that even when there is a change in the increase or decrease of the water intake flow amount, a stable residual chlorine target management can be obtained. In other words, even when the residual chlorine target value is changed like 0.10→0.06→0.15 mg/L due to the change in water quality such as the increase of ammonia nitrogen, (0.98 mg/L in maximum) the prechlorination practice ratio gradually increases(1.77-3.48 mg/L), so the stable residual chlorine target management can be obtained.

FIG. 9 is a view of an analysis screen of a prechlorination practice trend when water quality fast changes.

As shown in FIG. 9, referring to the graphs before improvements of the left side, when the ammonia nitrogen fast changes from minimum 0.10 to maximum 0.53 mg/L due to the fast change in water quality, the prechlorination practice ratio(2.75-9.64 mg/L) and the residual chlorine(0.14-1.3 mg/L) become very unstable.

However, as shown in FIG. 9, referring the graphs after improvements of the right side to which the present invention is adapted, when the ammonia nitrogen changes from minimum 0.51 to maximum 1.05 mg/L due to the fast change in water quality, the prechlorination practice ratio properly increases and decreases(1.79-6.43 mg/L), and it is known that the measured values(0.06→0.15→0.28→0.16 mg/L) in comparison to the target value of the residual chlorine(0.06→0.15→0.20 mg/L) are maintained very stably.

1. A PLC system for automatically controlling a PID for maintaining a target water quality value by depositing water treatment chemical, comprising:
a computer provided in a main control room which computer is equipped with a PID control software and generates a PID control command with respect to a chemical feed amount and transfer to a field control PLC of a chemical room;
a field control PLC provided in the chemical room which field control PLC receives a PID control command signal from the computer of the main control room and performs a calculation and control; and
a chemical feeder provided in the chemical room which chemical feeder receives a control signal of the field control PLC and feeds a chemical as much as commanded, and the computer of the main control room calculates an initial set value of the chemical feed amount based on Equation 1 and generates a PID control command,
initial set value=[current actual feed amount+(residual chemical target value−residual chemical actual measured value)]×flow amount, [Equation 1]
where in the equation, the current actual feed amount represents the actual feed ratio of the chemical in comparison to the treatment flow amount, and the residual chemical target value represents a concentration value of the residual chemical targeted after the chemical feed process, and the residual chemical actual measured value represents an actual measured value of the current residual chemical, and the flow amount represents the amount of water which is treated in the chemical feed field.

2. A PLC system for automatically controlling a PID for maintaining a target water quality value by depositing water treatment chemical according to claim 1, wherein the computer of the main control room sets a control range of a PID automatic control which control range is formed of a proportional factor, an integration factor, a calculation period and a compensation deviation which are defined by the capacities of the chemical feeder depending on the water quality for thereby generating a PID control command.

3. A PLC system for automatically controlling a PID for maintaining a target water quality value by depositing water treatment chemical according to claim 1, wherein the computer of the main control room compares at every second the current flow amount with the flow amount of one minute ago, and when the difference between the current flow amount and the flow amount of one minute ago is less than ±10%, the set value of the current chemical feed amount is maintained identically, and when the difference between the current flow amount and the flow amount of one minute ago is above ±10%, the flow amount compensation chemical feed set value is recalculated on the basis of Equation 2, for thereby generating a PID control command,
Flow amount compensation chemical feed amount set value=chemical feed amount before change of flow amount+[(current flow amount−flow amount of one minute ago)×chemical feed ratio before change of flow amount] [Equation 2]

4. A PLC system for automatically controlling a PID for maintaining a target water quality value by depositing water treatment chemical according to claim 3, wherein when the flow amount compensation is performed by the flow amount compensation chemical feed amount set value, the flow amount compensation is not performed for one minute.
